(19) United States
(12) Patent Application Publication
(10) Pub. No.: US 2026/0155047 A1
(43) Pub. Date: Jun. 4, 2026

(54) METHODS AND SYSTEMS FOR VEHICLE OPERATOR ASSISTANCE

(71) Applicant: HONEYWELL INTERNATIONAL INC., Charlotte, NC (US)

(72) Inventors: Srilakshmi Kurudi, Bangalore (IN); Gobinathan Baladhandapani, Madurai (IN); Karthikeyan M, Madurai (IN); Sivakumar Kanagarajan, Bangalore (IN)

(73) Assignee: HONEYWELL INTERNATIONAL INC., Charlotte, NC (US)

(21) Appl. No.: 19/020,558

(22) Filed: Jan. 14, 2025

(30) Foreign Application Priority Data
Nov. 29, 2024 (IN) 202411093619

(51) Int. Cl. G08G 5/21; G08G 5/26; G08G 5/54

(52) U.S. Cl. CPC G08G 5/21; G08G 5/26; G08G 5/54

(57) ABSTRACT

Cloud-based systems and methods are provided for proactively assisting a vehicle operator to mitigate a forecasted anomalous condition. An exemplary method involves obtaining, via one or more systems onboard a vehicle, status information indicative of a current state of the vehicle, forecasting an anomalous condition is likely for the vehicle based on a relationship between the current state of the vehicle and a first set of one or more historical vehicle states associated with prior occurrence of the anomalous condition, analyzing a second set of one or more historical vehicle states similar to the current state of the vehicle to identify a remedial operator action correlative to avoidance of the anomalous condition based on prior operator actions associated with the second set of one or more historical vehicle states, and providing an indication of the remedial operator action to the operator of the vehicle.

### CROSS REFERENCE TO RELATED APPLICATION

This application claims priority to India Provisional Patent Application No. 202411093619, filed Nov. 29, 2024, the entire content of which is incorporated by reference herein.

### TECHNICAL FIELD

The subject matter described herein generally relates to vehicle systems, and more particularly, embodiments of the subject matter relate to assisting pilots or other aircraft operators in response to an anomalous condition.

### BACKGROUND

Vehicles are frequently operated in accordance with a predefined route to a particular intended destination desired by a vehicle operator. For example, in an aviation context, a governmental or regulatory organization, such as, for example, the Federal Aviation Administration (FAA) in the United States, may publish procedural information, such as instrument approach procedures (e.g., Instrument Approach Procedure (IAP) charts), standard terminal arrival routes (e.g., Standard Terminal Arrival (STAR) charts or Terminal Arrival Area (TAA) charts), instrument departure procedures, standard instrument departure routes, obstacle departure procedures, or the like. Additionally, it is often desirable to operate aircraft in a stabilized manner, generally defined in terms of a number of specific criteria, which may be set forth by a safety organization (e.g., the Flight Safety Foundation), a standards organization or other regulatory body, an airline, an aircraft manufacturer, or the like.

Maintaining stabilized operations or achieving a stabilized approach can be a challenging task, especially in certain circumstances such as adverse weather conditions, on-board malfunctions, low quality of air traffic control (ATC), bad crew cooperation, fatigue, inexperienced crew members, and the like. In this regard, a number of aircraft accidents and incidents arise from runway overrun and veer-off events (collectively referred herein to as “runway excursions”). Runway excursions occur when the flight crew is unable to stop an aircraft within the available runway length due to, for example, runway contaminants such as rainwater, snow, ice, etc. This may result from an inadequate understanding of the current runway surface conditions or an inability to determine how the presence of contaminants on the runway surface (e.g., liquid water, snow, slush, ice, oil, rubber deposits, and the like) is likely to impact the aircraft braking performance. Additionally, meteorological conditions, such as wind speed, wind direction, atmospheric pressure, turbulence, temperature, and the like, can be variable and unpredictable, further complicating energy management and stabilized landings. Accordingly, it is desirable to provide assistance to pilots or other operators that accounts for meteorological conditions, runway surface conditions, and other factors in real-time to increase the likelihood of stabilized approaches and landings to improve safety and reduce mental workload while also reducing the likelihood of misjudgment or human error by inexperienced operators.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Cloud-based computing systems and related methods and apparatus are provided for proactively assisting a vehicle operator to mitigate a forecasted anomalous condition by providing indication of a recommended remedial action to be performed by the operator prior to occurrence of the forecasted anomalous condition. An exemplary method involves obtaining, via one or more systems onboard a vehicle, status information indicative of a current state of the vehicle, forecasting an anomalous condition is likely for the vehicle based on a relationship between the current state of the vehicle and a first set of one or more historical vehicle states associated with prior occurrence of the anomalous condition using a forecast model, analyzing a second set of one or more historical vehicle states similar to the current state of the vehicle to identify a remedial operator action correlative to avoidance of the anomalous condition based on prior operator actions associated with the second set of one or more historical vehicle states using a recommendation model, and providing an indication of the remedial operator action to the operator of the vehicle.

Other desirable features and characteristics of the subject matter described herein will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a block diagram illustrating a computing system configurable to support a cloud-based service in connection with operation of a vehicle such as an aircraft in accordance with one or more exemplary embodiments;

FIG. 2 is a block diagram illustrating a pilot assistance service suitable for implementation in the computing system of FIG. 1 in accordance with one or more exemplary embodiments;

FIGS. 3-4 depict an exemplary sequence of graphical user interface (GUI) displays suitable for presentation in connection with the pilot assistance service of FIG. 2 in the computing system of FIG. 1 in accordance with one or more exemplary embodiments; and

FIG. 5 is a flow diagram of a pilot assistance process suitable for implementation by pilot assistance service in the computing system of FIG. 1 in an exemplary embodiment.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, brief summary, or the following detailed description.

Embodiments of the subject matter described herein generally relate to systems and methods for assisting a vehicle operator using historical data to forecast or predict likelihood of occurrence of an anomalous event or condition and proactively provide recommended actions for the operator to preemptively perform to mitigate the anomalous condition prior to occurrence of the anomalous condition. In exemplary implementations, the recommended operator actions are identified or otherwise derived from historical data based on prior operator actions performed in connection with substantially similar historical vehicle states that are correlative to nonoccurrence or mitigation of the anomalous condition. In this manner, experiential recommended operator actions that were previously effective at avoiding or mitigating the anomalous condition are provided, thereby augmenting the operator's knowledge and experience and allowing the operator to operate the vehicle in a manner that is likely to improve safety while reducing workload. For purposes of explanation, the subject matter is described herein primarily in the context of aircraft; however, it should be appreciated the subject matter is not necessarily limited to use with aircraft and may be implemented in an equivalent manner for other types of vehicles (e.g., automotive vehicles, marine vessels, or the like).

In exemplary implementations, a pilot assistance service receives or otherwise obtains status information characterizing the current state of the aircraft from one or more onboard systems. The status information characterizing the current state of the aircraft may also include or otherwise incorporate current and/or forecasted meteorological conditions at the current location of the aircraft or for regions at or along a flight plan route to the intended destination airport for the aircraft. The current aircraft state information is input or otherwise provided to a model that is configured to forecast, predict or otherwise identify an anomalous condition that is likely to occur based on the similarity between the current aircraft state information and prior aircraft states where the anomalous condition was subsequently encountered based on historical flight data. In this regard, historical data associated with prior flights may be stored, captured or otherwise maintained, where the historical data for a respective prior flight includes time series data including information characterizing the respective states of the aircraft during the respective prior flight along with corresponding actions performed during the flight by the respective pilot that is also tagged or otherwise designated with information identifying or characterizing occurrence of any anomalous conditions or events associated with the respective flight. Thus, each set or sequence of time series data associated with a respective prior flight may include measurements of various aircraft parameters (e.g., speed, altitude, heading, gross weight, fuel remaining, etc.), aircraft configurations (e.g., flap configurations, airbrake settings, and/or the like), and other actions manually initiated or performed by the pilot along with historical data for meteorological conditions or other atmospheric conditions encountered by the aircraft at respective points in time, runway surface conditions or other factors (e.g., runway length and the like) and any anomalous conditions encountered (e.g., tail strike, hard landing, runway overrun, runway veer off, etc.).

In exemplary implementations, the historical time series data for prior flights is utilized as a training data set for purposes of training a landing forecast model realized as a recurrent neural network (RNN) for predicting the probability or likelihood of a respective anomalous condition at a future point in time as a function of an input series or sequence of aircraft states. Thus, the obtained status information indicative of the current state of the aircraft during a current flight may be continually input or otherwise provided to the RNN of the landing forecast model to detect or otherwise identify when an anomalous condition is likely to occur with a probability greater than a threshold detection probability (e.g., greater than 50%). In this regard, it should be noted that the landing forecast model is not limited to an RNN, and in practice, other machine learning or artificial intelligence techniques may be utilized to derive a model for predicting occurrence of an anomalous condition in an equivalent manner.

In response to forecasting or predicting the likely occurrence of an anomalous condition in the future based on the current aircraft state information, the pilot assistance service identifies one or more pilot actions that are correlative to avoidance or mitigation of the anomalous condition based on prior pilot actions associated with historical aircraft states that are sufficiently similar to the current aircraft state. In this regard, the pilot assistance service may analyze a set of one or more prior flights including historical aircraft states that are substantially similar to the current aircraft state to identify, based on those prior flights, what prior pilot actions associated with those prior flights are most correlative to the absence or non-occurrence of the anomalous condition, or otherwise correlate to a desired outcome (e.g., a stable approach, a soft landing, and/or the like) that mitigates the forecasted anomalous condition. For example, in some implementations, the historical time series data for prior flights may be utilized as a training data set for purposes of training a recommendation model for identifying pilot actions that are correlative to a desired outcome (e.g., a stable approach, a soft landing, etc.) given a subset of historical aircraft states substantially similar to the current aircraft state using machine learning or other artificial intelligence techniques.

In exemplary implementations, the pilot assistance service generates or otherwise provides one or more graphical indicia of any anomalous condition(s) forecasted for the aircraft and recommended remedial operator actions that could be performed by the pilot, co-pilot or other operator of the aircraft to mitigate the anomalous condition. For example, when the landing forecast model predicts an unstabilized approach and hard landing is likely to occur based on the current aircraft state given current wind gusts or other meteorological conditions and similarity to prior historical aircraft states that resulted in hard landings from unstabilized approaches given similar meteorological conditions and aircraft states, the pilot assistance service may determine that activation of the takeoff/go-around (TOGA) switch is recommended to initiate a go-around or other missed approach pattern based on the subset of historical aircraft states and/or flights where other aircraft were able to subsequently achieve a stable approach and provide a corresponding indication to the pilot or other operator to activate the TOGA switch and perform a go-around. Thus, a pilot does not need to manually ascertain how to mitigate the unstabilized approach in real-time after loss of stabilization and does not need to risk attempting other operator actions that are unlikely to resolve the unstabilized approach or which were previously unsuccessful for other aircraft during prior flights that resulted in a hard landing due to an unstabilized approach. Rather, the pilot can proactively perform the recommended action and continue operating the aircraft with improved situational awareness of the potential anomalous condition and what actions should be performed to mitigate the anomaly (e.g., flying a missed approach or go-around in a manner that reduces or otherwise manages energy for improve stability).

As another example, when the landing forecast model predicts a runway overrun is likely to occur as a result of an incorrect touchdown point caused by a tail wind given the current aircraft state based similarity to prior historical aircraft states that resulted in runway overrun from similar tail winds and similar aircraft states, the pilot assistance service may determine that flying a flatter approach path with flaps extended to a setting corresponding to a 25° flap angle is recommended based on the subset of historical aircraft states and/or flights with similar tail winds where other aircraft were able to avoid runway overrun and provide a corresponding indication of the recommended flap setting to the pilot or other operator. Thus, an inexperienced pilot does not need to manually ascertain how to account for tail winds in real-time, but rather can rely on prior pilot behaviors from prior flights that were successful under similar meteorological conditions from similar aircraft states.

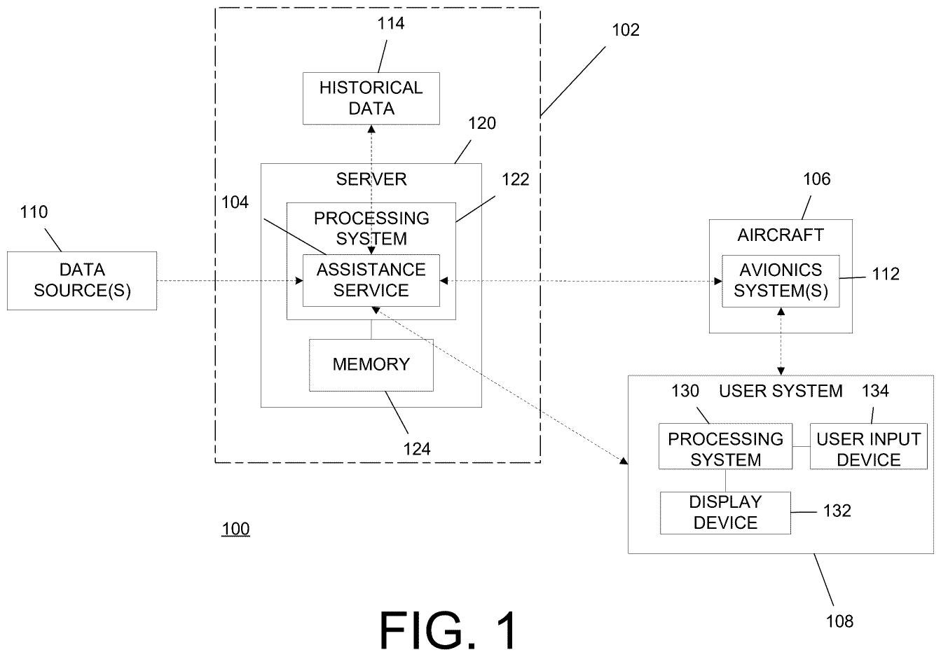

FIG. 1 depicts an exemplary system 100 that includes a cloud-based computing system 102 capable of supporting a pilot assistance service 104 configurable to provide graphical indicia of different forecasted anomalous conditions for a vehicle 106 and recommended operator actions for mitigating any forecasted anomalous conditions in response to detecting or otherwise identifying an anomalous condition that is likely to occur based on historical data pertaining to prior operations of other vehicles. For purposes of explanation, the subject matter is described herein in the context of the vehicle 106 being realized as an aircraft; however, it should be appreciated that the subject matter described herein is not intended to be limited to any particular type of vehicle 106 or user system 108 where graphical indicia may be provided. In this regard, in some implementations, the aircraft 106 may be realized as an unmanned aerial vehicle (UAV) or other vertical takeoff and land (VTOL) aircraft that may be remotely operated by a user of a remote control device 108. That said, the subject matter may be described herein may be described in the context of a manned aircraft 106 where the user system 108 is realized as an electronic flight bag (EFB) or other control device onboard the aircraft 106 for reference or use by the pilot of the aircraft 106 while flying the aircraft 106.

In exemplary implementations, any number of different external systems, devices or other data sources 110 may be communicatively coupled to the cloud-based computing system 102 over any sort of communications network, such as, for example, the Internet, a cellular network, a mobile network, a local area network (LAN), a wide area network (WAN), or any other suitable telecommunications network. For example, in practice, any number of external systems may be communicatively coupled to the cloud-based computing system 102 to provide information pertaining to operation of the aircraft 106 being monitored for purposes of providing real-time assistance. In various implementations, the external systems include one or more weather mthe operation system(s) (e.g., a Doppler radar monitoring system, a collaborative convective forecast product (CCFP) or national convective weather forecast (NCWF) system, an infrared satellite system, etc.), reporting systems (e.g., a Notice to Airmen (NOTAM) system, a Pilot Reporting (PIREP) system, or the like), broadcast systems (e.g., Automated Terminal Information Service (ATIS), an Automatic Dependent Surveillance- Broadcast (ADS-B) system, or the like), communications systems (e.g., a controller-pilot data link system (CPDLC), an Air Traffic Control (ATC) system, or the like) or other external systems suitable for providing current or real-time information pertaining to operation of an aircraft 106 within a particular geographic region. Additionally, the external data sources 110 may include one or more databases, such as, for example, an airport database, a terrain database, an obstacle database and/or the like. It should be appreciated that the subject matter described herein is not limited to any particular type or number of data sources from which supplemental information may be obtained by the pilot assistance service 104.

In addition to data sources 110, in exemplary implementations, the pilot assistance service 104 at the cloud-based computing system 102 is configurable to obtain status information indicative of the current state of the aircraft 106 from one or more systems 112 that are located onboard or otherwise associated with the aircraft 106. In this regard, in an aviation context, the onboard systems 112 generally represents any sort of avionics system capable of providing data and/or information regarding the operation of the aircraft 106, such as, for example, a flight management system (FMS), a navigation system, a communications system, an autopilot system, an autothrust system, a weather system, an air traffic management system, a radar system, a traffic avoidance system, hydraulics systems, pneumatics systems, environmental systems, electrical systems, engine systems, trim systems, lighting systems, crew alerting systems, electronic checklist systems, an electronic flight bag and/or another suitable avionics system. Although FIG. 1 depicts the pilot assistance service 104 receiving the current status information from the onboard avionics system(s) 112 directly over a communications network, in alternative implementations, the pilot assistance service 104 may receive the current status information from the onboard avionics system(s) 112 indirectly via the control device 108.

The control device 108 generally represents an electronic device capable of communicating with one or more avionics systems 112 associated with the aircraft 106 to manage, influence or otherwise control operation of the aircraft 106. In this regard, in a UAV or VTOL context, the control device 108 may be realized as a flight controller or other remote controller associated with the aircraft 106. That said, in other implementations, the control device 108 could be realized as any sort of client electronic device, such as, for example, an electronic flight bag (EFB), a mobile phone, a smartphone, a tablet computer, a laptop computer, and/or the like. In yet other embodiments, the control device 108 could be realized as a multi-function control and display unit (MCDU) or another hardware component that is incorporated with the flight deck or cockpit of the aircraft 106. In exemplary implementations, the control device 108 generally includes an electronic display device 132 capable of graphically presenting data and/or information along with one or more user input devices 134 capable of receiving input from the user of the control device 108, and a processing system 130 that includes or is otherwise coupled to a data storage element having programming instructions or code that, when read and executed, cause the processing system to generate one or more GUI displays on the display device 132 and support the subject matter described herein.

Still referring to FIG. 1, the illustrated cloud-based computing system 102 includes at least one server 120, which generally represents a server computing device or system that includes at least one processing system 122, which generally represents the control module or other hardware suitably configured to support the pilot assistance service 104 and other operations of the server 120 described herein. In this regard, the processing system 122 may include or otherwise be realized using a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processing system 122 includes or otherwise accesses a data storage element 124 (or memory), which may be realized as any sort of non-transitory short-or long-term storage media capable of storing programming instructions for execution by the processing system 122. The code or other computer-executable programming instructions, when read and executed by the processing system 122, cause the processing system 122 to support or otherwise perform certain tasks, operations, functions, and/or processes described herein. Depending on the embodiment, the memory 124 may be physically realized using random-access memory (RAM), read-only memory (ROM), flash memory, registers, a hard disk, or another suitable data storage medium known in the art or any suitable combination thereof.

In exemplary implementations, the computer-executable programming instructions are executed by the processing system 122 to generate, execute, or otherwise implement the pilot assistance service 104 that is configurable to receive information or data indicative of the current state of the aircraft 106 from one or more onboard systems 112 and analyze the current state of the aircraft 106 with respect to a flight plan for the aircraft 106 and/or supplemental information obtained from one or more other data sources 110 to predict, forecast or otherwise detect likely occurrence of an anomalous condition with respect to the aircraft 106 completing execution of the flight plan and landing at its intended destination based on relationships between the current state of the aircraft 106 with respect to the flight plan and substantially similar historical aircraft states from prior flights derived from analysis of the historical data 114. In response to predicting or forecasting an anomalous condition, the pilot assistance service 104 automatically identifies one or more recommended actions for execution or initiation by a pilot or other operator of the aircraft 106 to mitigate the anomalous condition based on the historical data 114 by identifying prior flights with substantially similar historical aircraft states where the anomalous condition was avoided and identifying a correlation between prior pilot actions from those prior flights and nonoccurrence of the anomalous condition. In this regard, in exemplary implementations, the cloud-based computing system 102 stores or otherwise maintains historical data 114 pertaining to historical flights including aircraft state information and other contextual information (e.g., meteorological conditions and/or the like) in a time series format, with the respective time series data set for a respective flight being tagged or marked with information identifying anomalous conditions experienced during the respective prior flight to allow the pilot assistance service 104 to dynamically calculate or otherwise determine the probability of a particular action by a pilot or other operator of a respective aircraft achieving a particular outcome for the current flight that may be desired by the pilot or operator of the aircraft 106. In some implementations, the historical data 114 includes data sets including measurement data or samples obtained or collected during test flights and uploaded or stored post-flight along with event-based data sets that include measurement data or samples along with pilot action data obtained or collected during in-service flights encountering an anomalous condition or event and uploaded or stored post-flight.

As described in greater detail below, after detecting probable occurrence of an anomalous condition, the pilot assistance service 104 transmits or otherwise provides indication of the anomalous condition to the control device 108 along with commands, instructions, data or other information suitable for execution by the processing system 130 to render or otherwise generate a GUI display on the display device 132 that includes graphical indicia of the forecasted anomalous condition. The aircraft operator may utilize the GUI display to ascertain the forecasted anomalous condition and analyze recommended remedial actions for mitigating the forecasted anomalous condition that were identified by the pilot assistance service 104 based on the historical data 114. In some implementations, the pilot assistance service 104 provides one or more selectable GUI elements, where in response to selection of a GUI element pertaining to a recommended action, the pilot assistance service 104 transmits or otherwise provides corresponding commands, instructions, data or other information to one or more avionics systems 112 onboard the aircraft 106 (either directly over a communications network or indirectly via the control device 108) to facilitate the pilot initiating the recommended remedial action. In this regard, in some implementations, the pilot assistance service 104 may be configurable to program or otherwise configure the onboard avionics system(s) 112 to autonomously operate the aircraft 106 to implement a recommended remedial action identified by the pilot assistance service 104 without requiring the pilot or aircraft operator to manually interact with or otherwise reprogram a respective onboard avionics system 112.

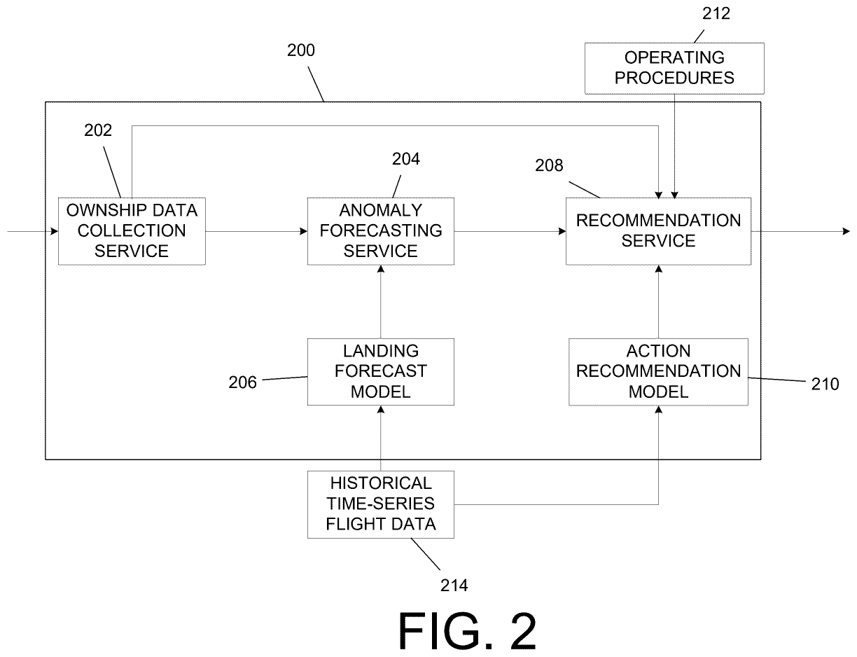

FIG. 2 depicts an exemplary block diagram of a pilot assistance service 200 suitable for use as the pilot assistance service 104 in the cloud-based computing system 102 of FIG. 1. The pilot assistance service 200 includes an ownship data collection service 202 that generally represents the process, subroutine or other component associated with the pilot assistance service 200 that retrieves, receives or otherwise obtains data associated with the current flight of the ownship aircraft from available data sources and formats, organizes or otherwise maintains the data pertaining to the current flight in a time series format to facilitate comparison to historical time series flight data. In this regard, the ownship data collection service 202 receives or otherwise obtains data or other information characterizing the current real-time state of the ownship aircraft 106 at different points in time from one or more onboard avionics systems 112 and stores or otherwise maintains the current aircraft state data in a sequential or time series manner (e.g., by using timestamps to maintain temporal associations between substantially contemporaneous data values for different aircraft state parameters). Additionally, the ownship data collection service 202 concurrently receives or otherwise obtains data or other information pertaining to the current flight from one or more additional data sources 110 and stores or otherwise maintains the contextual state data in a sequential or time series manner in association with the time series aircraft state data. For example, the ownship data collection service 202 may obtain data characterizing the meteorological conditions at or near the geographic location of the ownship aircraft 106, the destination airport, and/or other waypoints along the flight plan route from one or more weather monitoring system(s). Additionally, the ownship data collection service 202 may obtain data characterizing the meteorological conditions or other contextual information pertaining to the geographic location of the ownship aircraft 106, the destination airport, and/or other waypoints along the flight plan route from a NOTAM system, a PIREP system, an ATIS system, a CPDLC system, an ATC system, and/or the like.

In exemplary implementations, the ownship data collection service 202 obtains a Runway Condition code (RWYCC) or other contaminant or runway surface condition data from a NOTAM or other external data source that categorizes or classifies the runway surface condition into different categories or codes ranging a best performing surface condition (e.g., dry) to a worst performing surface condition (e.g., wet ice, slush over snow, water over compacted snow, and/or dry snow or wet snow over ice, or the like) for one or more segments of the destination runway. Additionally, the ownship data collection service 202 obtains braking requirements, brake band data, or other braking performance data for the destination runway from a takeoff and landing data (TOLD) system, a runway overrun awareness and alerting system (ROAAS), or another suitable data source. The ownship data collection service 202 obtains runway usage information and/or ownship clearance information for the destination airport from an ATC system or other communications system or the filed flight plan, with the wind data (speed, direction and gusts), outside air temperature (OAT), the barometric altimeter setting (QNH value), humidity data and other information associated with the destination airport from an ATIS system, a weather radar system, or another suitable data source. Additional aircraft parameters (e.g., aircraft model, aircraft weight, approach speed, recommended settings and the like), control settings (e.g., flap or slat positions, thrust level, and the like), and aircraft state data (e.g., geographic location, speed, heading, altitude, and/or the like) are obtained by the ownship data collection service 202 from the onboard avionics systems 112 (e.g., via an avionics standard communication bus (ASCB)) or another data source 110 (e.g., an aero-engine database (AEDB) or another suitable aircraft database) for analysis in combination with the approach and runway state data to predict, forecast or otherwise detect a probable anomalous condition with respect to landing the ownship aircraft, as described in greater detail below.

The anomaly forecasting service 204 generally represents the process, subroutine or other component associated with the pilot assistance service 200 that retrieves, receives or otherwise obtains input time series data associated with the current flight from the ownship data collection service 202 and analyzes or otherwise compares the input time series data associated with the current flight to historical time series data associated with prior flights to detect or otherwise identify probable occurrence of an anomalous condition based on relationships between the current state of the ownship aircraft 106 and similar historical aircraft states associated with substantially similar operational contexts. In this regard, in exemplary implementations, the anomaly forecasting service 204 utilizes a landing forecast model 206 that is configurable to forecast or predict probable outcomes associated with the current flight based on relationships between the current state of the ownship aircraft 106 and the current state and/or meteorological conditions associated with the destination airport and/or runway and similar historical aircraft states associated with substantially similar operational contexts (e.g., similar runway surface conditions, similar winds, similar aircraft models and/or aircraft weights, and/or the like).

In exemplary implementations, the landing forecasting model 206 includes or otherwise utilizes a model realized as a recurrent neural network (RNN) time series model that includes a set of input nodes that receive respective streams of time series data representing values or measurements of various aircraft state parameters, meteorological conditions, runway conditions, pilot actions, and the like that contribute to a successful landing of the flight, or alternatively, occurrence of anomalous condition during the flight. The landing forecasting model 206 is trained or otherwise developed by consuming historical time series flight data 214 that includes time series aircraft state data along with meteorological data, runway condition data and potentially other post flight data (e.g., flight data recorder (FDR) data, ATC transcription data, maintenance logs, and the like) for a respective flight that is tagged, marked or otherwise designated with the respective landing outcomes observed or otherwise exhibited during that respective prior flight, including anomalous conditions with respect to landing, such as, for example, an unstable approach, a hard landing, a tail strike, a runway overrun, a runway veer off, and/or the like. In this manner, the RNN-based time series model is trained to predict the probability of occurrence of a particular landing outcome as a function of a respective input set of time series data streams corresponding to the current flight.

The anomaly forecasting service 204 inputs or otherwise provides the respective time series data streams associated with the current flight to the landing forecast model 206 to dynamically detect or otherwise determine when the probability of occurrence of a particular anomalous condition is greater than a detection threshold based on the current aircraft state and other contextual data pertaining to the current flight (e.g., meteorological conditions at the destination airport, runway conditions for the destination runway, and/or the like). When the anomaly forecasting service 204 detects that the current aircraft state and current contextual operational factors pertaining to the current flight are likely to result in an anomalous condition with at least a minimum threshold of probability, the anomaly forecasting service 204 provides a corresponding indication of the detected anomalous condition to a recommendation service 208.

The recommendation service 208 generally represents the process, subroutine or other component associated with the pilot assistance service 200 that retrieves, receives or otherwise obtains input time series data associated with the current flight from the ownship data collection service 202 and analyzes or otherwise compares the input time series data associated with the current flight to historical time series data associated with prior flights to identify a potential pilot action that is correlative to avoidance of an anomalous condition and/or correlative to a desired outcome based on relationships between the current state of the ownship aircraft 106 and prior pilot actions performed in connection with similar historical aircraft states associated with substantially similar operational contexts that achieved the desired outcome. In this regard, in exemplary implementations, the recommendation service 208 utilizes an action recommendation model 210 that is configurable to identify or otherwise predict one or more pilot actions that, if performed in connection with the current flight, would be likely to achieve a desired outcome with at least a minimum threshold of probability based on relationships between the current state of the ownship aircraft 106 and the current state and/or meteorological conditions associated with the destination airport and/or runway and similar historical aircraft states associated with substantially similar operational contexts (e.g., similar runway surface conditions, similar winds, similar aircraft models and/or aircraft weights, and/or the like).

In exemplary implementations, similar to the landing forecasting model 206, the action recommendation model 210 may include or otherwise utilize a RNN-based time series model that includes a set of input nodes that receive respective streams of time series data representing values or measurements of various aircraft state parameters, meteorological conditions, runway conditions, pilot actions, and the like that characterize a respective flight under analysis. In some implementations, the action recommendation model 210 also receives as input an indication of a predicted or forecasted anomalous condition with respect to a respective flight and the respective probability of occurrence at a particular point in time. In this regard, the action recommendation model 210 is trained or otherwise developed using historical time series flight data 214 to identify correlations between pilot actions and non-occurrence of particular anomalous conditions that would otherwise be predicted or expected based on the landing forecast model 206. In this manner, the RNN-based time series action recommendation model 210 is trained to identify a potential remedial action that is likely to reduce the probability of occurrence of an anomalous condition and/or increase the probability of a desired landing outcome as a function of a respective input set of time series data streams corresponding to the current flight and any forecasted anomalous condition for the current flight.

The recommendation service 208 inputs or otherwise provides the respective time series data streams associated with the current flight to the action recommendation model 210 along with indicia of any forecasted anomalous condition and its respective probability or likelihood to dynamically identify or otherwise determine what remedial action is likely to reduce the probability of occurrence of the forecasted anomalous condition and/or increase the probability of occurrence of a desired landing outcome based on relationships between the current aircraft state and other contextual data pertaining to the current flight (e.g., meteorological conditions at the destination airport, runway conditions for the destination runway, and/or the like) and substantially similar prior aircraft states and contexts where the respective remedial pilot actions where correlative to avoidance of the anomalous condition and/or occurrence of the desired landing outcome.

In one or more exemplary implementations, the recommendation service 208 utilizes one or more rules or other standard operating procedures (SOPs) 212 associated with the aircraft to augment or otherwise modify the output of the action recommendation model 210 prior to providing a user indication of a recommended remedial action. For example, when the output of the action recommendation model 210 comprises a particular value for a setting or other parameter for operating the aircraft, the recommendation service 208 may utilize the SOPs 212 associated with the aircraft to verify or otherwise validate the value is within a permissible range of values for the aircraft and automatically modify, augment or otherwise adjust a value output by the action recommendation model 210 to comport with the SOPs 212. In this regard, if the action recommendation model 210 output a braking level, flap position, or other configuration parameter or setting value that the SOPs 212 restrict, limit or otherwise prevent given the current aircraft state, the recommendation service 208 may automatically adjust or augment the value to the closest value permitted for the aircraft in accordance with the SOPs 212. Alternatively, the recommendation service 208 may discard or otherwise reject a recommended remedial action that cannot be validated under the applicable SOPs 212 and select the next best remedial action recommended by the action recommendation model 210, that is, the recommended remedial action having the second highest correlation or probability with a desired outcome given the current aircraft state.

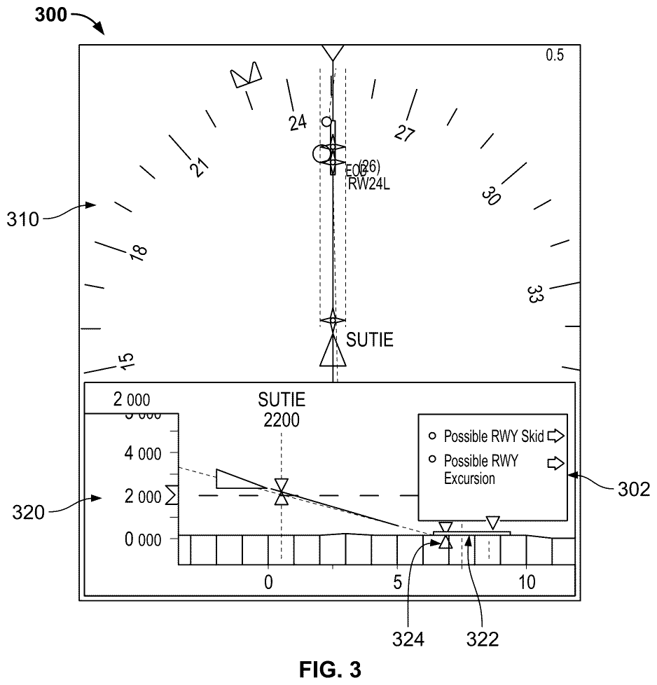

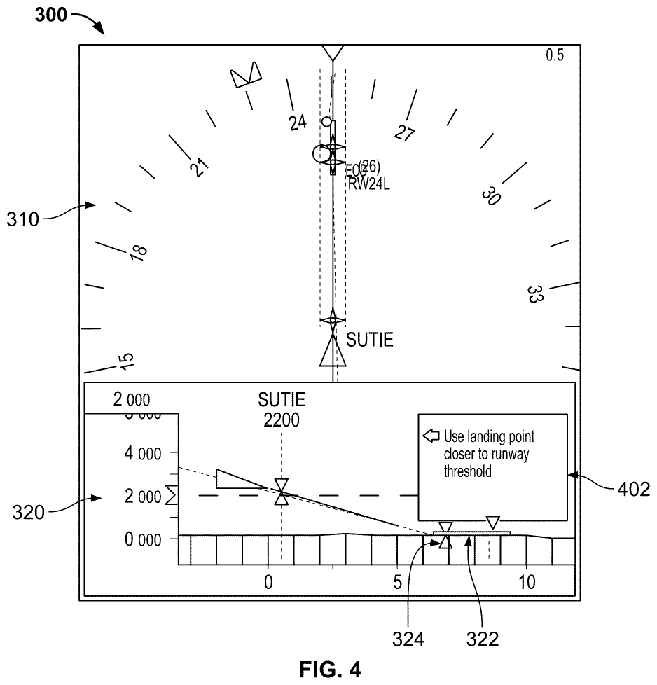

Referring now to FIGS. 3-4, with continued reference to FIGS. 1-2, in exemplary implementations, when the pilot assistance service 104, 200 detects that the current aircraft state and other real-time contextual operational factors pertaining to the current flight are likely to result in an anomalous condition with at least a minimum threshold of probability, the pilot assistance service 104, 200 automatically generates or otherwise provides one or more user notifications including indicia of the forecasted anomalous condition(s) and the recommended remedial action(s) for mitigating any forecasted anomalous condition(s). In this regard, FIG. 3 depicts a navigational graphical user interface (GUI) display 300 suitable for presentation on a display device associated with an aircraft 106, such as a display device associated with an MCDU, EFB, or other onboard avionics system 112 or a user system 108 associated with the aircraft 106. In response to the anomaly forecasting service 204 detecting a forecasted anomalous condition with a threshold probability, the pilot assistance service 104, 200 transmits or otherwise provides a corresponding indication to the processing system 130 that is configured to cause the processing system 130 to generate, render or otherwise provide a graphical user notification 302 on or overlying the GUI display 300 that provides graphical indicia of the particular type of anomalous condition forecasted for the aircraft 106.

The GUI display 300 of FIG. 3 includes a navigational map display 310 in a lateral (or horizontal) dimension and a vertical profile display 320 adjacent to the navigational map display 310 that concurrently depicts a vertical profile corresponding to the planned lateral route defined by the flight plan depicted on the navigational map display 310. In this regard, the navigational map 310 may include a graphical representation of a portion of the route defined by a flight plan while the vertical profile display 320 includes a graphical representation of the vertical profile of the portion of the flight plan route depicted on the navigational map 310 that is ahead of the aircraft or is otherwise yet to be flown by the aircraft. The illustrated vertical profile display 320 includes a graphical representation 322 of a destination runway that includes a graphical indication 324 of an expected location of the touchdown point on the runway. When the pilot assistance service 104, 200 detects that the current aircraft state and other real-time contextual operational factors pertaining to the current flight are likely to result in an anomalous condition with respect to landing at the destination runway, the pilot assistance service 104, 200 automatically generates or otherwise provides the graphical user notification 302 as a graphical indication on, overlying or adjacent to the graphical representation 322 of the runway to visually indicate a potential anomalous condition with respect to the destination runway. As shown, the graphical user notification 302 may include a window, dialog box, text box or another suitable GUI element for displaying, presenting or otherwise providing descriptive information or text characterizing the potential anomalous condition on the vertical profile display 320 proximate the graphical representation 322 of the runway.

Referring now to FIG. 4, in response to selection of the graphical user notification 302 to view recommended remedial pilot actions, the processing system 130 may transmit or otherwise provide a corresponding request for a recommended remedial pilot action to the pilot assistance service 104, 200, which, in turn, causes the recommendation service 208 to dynamically determine a recommended remedial pilot action given the current state of the aircraft 106 using the action recommendation model 210 as described above. In response to selection of the graphical user notification 302, the pilot assistance service 104, 200 transmits or otherwise provides a corresponding indication of the recommended remedial pilot action(s) identified using the action recommendation model 210 to the processing system 130 that is configured to cause the processing system 130 to generate, render or otherwise provide an updated graphical user notification 402 on or overlying the GUI display 300 that provides graphical indicia of the recommended remedial action to be initiated or otherwise performed by the pilot to mitigate the forecasted anomalous condition. For example, the updated graphical user notification 402 may be displayed or rendered in place of the initial graphical user notification 302 as a graphical indication on, overlying or adjacent to the graphical representation 322 of the runway to visually indicate the recommended remedial action with respect to landing at the runway proximate the graphical representation 322 of the runway. In some implementations, the graphical user notification 402 of the recommended remedial pilot action may be realized using a button, hyperlink or other suitable selectable GUI element that, when selected, causes the processing system 130 and/or the pilot assistance service 104, 200 to transmit or otherwise provide corresponding instructions to the appropriate avionics system 112 onboard the aircraft 106 to automatically configure the avionics system 112 to implement the remedial action and thereby initiate the recommended remedial pilot action. In this manner, the pilot assistance service 104, 200 reduces the workload on the pilot while also saving time (thereby increasing time on task for other tasks) and alleviating potential inexperience by providing experiential recommendations that are likely to increase the probability of a desired outcome.

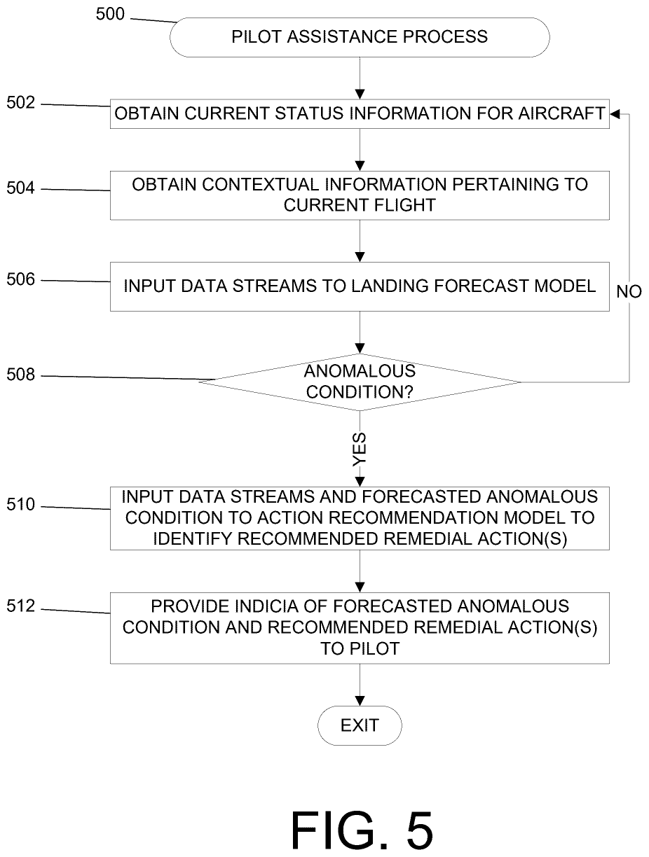

FIG. 5 depicts an exemplary embodiment of a pilot assistance process 500 suitable for implementation by a monitoring service associated with a vehicle, such as a cloud-based pilot assistance service 104, 200 monitoring operation of an aircraft 106. The various tasks performed in connection with the illustrated process may be implemented using hardware, firmware, software executed by processing circuitry, or any combination thereof. For illustrative purposes, the following description may refer to elements mentioned above in connection with FIG. 1. In practice, portions of the pilot assistance process 500 may be performed by different elements of the computing system 100. That said, exemplary embodiments are described herein in the context of the pilot assistance process 500 being primarily performed by the pilot assistance service 104 at the cloud-based computing system 102. It should be appreciated that the pilot assistance process 500 may include any number of additional or alternative tasks, the tasks need not be performed in the illustrated order and/or the tasks may be performed concurrently, and/or the pilot assistance process 500 may be incorporated into a more comprehensive procedure or process having additional functionality not described in detail herein. Moreover, one or more of the tasks shown and described in the context of FIG. 5 could be omitted from a practical embodiment of the pilot assistance process 500 as long as the intended overall functionality remains intact.

The illustrated pilot assistance process 500 receives or otherwise obtains current status information for an ownship aircraft along with supplemental contextual information available from one or more additional different data sources and continually analyzes or otherwise monitors the current status information with respect to historical flight data to forecast a potential anomalous condition with respect to continued operation of the aircraft (tasks 502, 504, 506, 508). In exemplary implementations, one or more avionics systems 112 onboard the aircraft 106 are configurable to transmit, upload or otherwise provide information indicative of the current state of the aircraft 106 to an ownship data collection service 202 associated with the pilot assistance service 104 at the cloud-based computing system 102 periodically or asynchronously on a substantially continual basis, such that the pilot assistance service 104 obtains information characterizing the current state of the aircraft 106 substantially in real-time.

For example, a FMS or similar system associated with the aircraft 106 may upload or otherwise provide information indicative of the current flight plan being flown by the aircraft 106 along with status information indicative of the current aircraft configuration or operational state (e.g., current engine status, current battery status, current fuel remaining, etc.) as well as the current spatial progress of the aircraft 106 traveling along the flight plan, including, but not limited to, the current geographic location of the aircraft 106, the current altitude of the aircraft 106, the current speed of the aircraft 106, the current heading of the aircraft 106, and/or the like. Additionally, the ownship data collection service 202 associated with the pilot assistance service 104 may continually receive or otherwise obtain supplemental information from different data sources 110 that are available or otherwise connected to the cloud-based computing system 102 over a communications network. For example, the ownship data collection service 202 may obtain meteorological information from an external data source 110 indicative of the current or forecasted meteorological conditions along the route associated with the aircraft 106 or otherwise pertaining to a geographic area encompassing the current geographic location of the aircraft 106 and/or the flight plan route. Similarly, the ownship data collection service 202 may obtain runway condition information, air traffic information, airspace restriction information, PIREPs information, NOTAMs information, and/or the like from external data sources 110. As described above, in exemplary implementations, the anomaly forecasting service 204 inputs or otherwise provides the current or real-time values of the respective time series data streams for the respective current aircraft status parameters and other contextual operating parameters received via the ownship data collection service 202 into the landing forecast model 206 to detect or otherwise identify when the probability of an anomalous condition is greater than a minimum detection threshold probability.

When the pilot assistance process 500 identifies or otherwise detects the probability of an anomalous condition in the future is greater than the minimum detection threshold probability, the pilot assistance process 500 inputs or otherwise provides indication of the forecasted anomalous condition to an action recommendation model along with the respective time series data streams for the respective current aircraft status parameters and other contextual operating parameters to identify one or more recommended remedial actions that are likely to mitigate the forecasted anomalous condition or otherwise achieve a desired outcome given the current aircraft state. For example, as described above, the recommendation service 208 inputs or otherwise provides the current or real-time values of the respective time series data streams for the respective current aircraft status parameters and other contextual operating parameters received via the ownship data collection service 202 into the action recommendation model 210 along with indication of the forecasted anomalous condition identified by the anomaly forecasting service 204 to configure the action recommendation model 210 to output a recommended remedial pilot action that is likely to reduce the probability of occurrence of the forecasted anomalous condition. After identifying an initial recommended remedial pilot action using the action recommendation model 210, in some implementations, the recommendation service 208 may utilize one or more SOPs 212 to augment or otherwise modify the recommended remedial pilot action before providing corresponding indication of the recommended remedial pilot action to a user.

After identifying a recommended remedial pilot action, the pilot assistance process 500 generates or otherwise provides indicia of the forecasted anomalous condition(s) and recommended remedial action(s) for mitigating the forecasted anomalous condition(s) to the pilot or other operator (task 512). For example, as described above in the context of FIGS. 3-4, the pilot assistance service 104, 200 may generated or otherwise provide one or more graphical user notifications 302, 402 that are interactive or otherwise manipulable by a pilot or other user to review and analyze the forecasted anomalous condition(s) and the recommended remedial action(s) and implement the recommended remedial action(s) as desired.

Referring to FIG. 2 with continued reference to FIGS. 1 and 5, in exemplary implementations, after completion of the current flight, a respective data set for the current flight may be added or otherwise incorporated into the historical data 114, 214 for purposes of retraining the models 206, 210. For example, the values of the respective time series data streams for the respective current aircraft status parameters and other contextual operating parameters received via the ownship data collection service 202 may be stored or otherwise maintained in a time series format using the respective timestamps associated therewith. Additionally, the respective data set for the current flight may also include information identifying any anomalous conditions forecasted at the respective point(s) in time during the flight and the respective probabilities associated therewith, along with information identifying any pilot action(s) performed during the current flight at respective point(s) in time. The respective data set for the current flight may also be tagged, marked or otherwise designated with one or more indicia of the respective outcome of the flight, including indicia of any anomalous conditions that may have occurred or were otherwise exhibited during or after the flight. In this regard, when the pilot performs the recommended remedial pilot action to successfully avoid an unstable approach, a hard landing, a runway overrun and/or the like, the action recommendation model 210 may be more likely to recommend that remedial pilot action during subsequent flights exhibiting substantially similar aircraft and/or contextual operating states. On the other hand, when the recommended remedial pilot action is insufficient to avoid the forecasted anomalous condition, the landing forecast model 206 may be more likely to forecast that anomalous condition with higher probability during subsequent flights exhibiting substantially similar aircraft and/or contextual operating states, while the action recommendation model 210 may be more likely to recommend a different remedial pilot action that is more correlative with nonoccurrence of the forecasted anomalous condition during subsequent flights exhibiting substantially similar aircraft and/or contextual operating states. In this manner, the models 206, 210 may be dynamically retrained and adapted as the amount of historical time-series flight data 114, 214 increases to improve performance of the models 206, 210 over time. Additionally, it should be noted that although the subject matter may be described herein in the context of the models 206, 210 being realized as RNN-based time series models, any number of different machine learning or artificial intelligence techniques may be utilized to determine what input state variables are predictive of or correlative to occurrence of a particular anomalous condition, or what pilot actions are predictive of or correlative to nonoccurrence of a particular anomalous condition, such as, for example, artificial neural networks, reinforcement learning, genetic programming, support vector machines, Bayesian networks, probabilistic machine learning models, and/or the like.

By virtue of the subject matter described herein, a cloud-based pilot assistance service 104, 200 supporting the pilot assistance process 500 is capable of proactively providing a pilot or other aircraft operator guidance regarding potential anomalous conditions and corresponding actions for mitigating those anomalous conditions in an efficient and experiential manner that reduces pilot workload and improves the likelihood of a successful outcome while compensating for potential inexperience, mental errors, and/or the like. For example, aircraft landing demands utmost precision and safety, where weather characteristics and behavior of the Earth's atmosphere are the most uncertain and influential (either directly or indirectly) factors with respect to having a safe landing. Runway overrun is typically caused by lack of available runway length after touch down, delayed action by the flight crew in the use of braking devices to decelerate the aircraft, misjudgment or misunderstanding of runway surface conditions, wind and turbulence, aircraft weight, touch down speed, and the like. The pilot assistance process 500 improves the operational efficiency of the pilot by giving a prediction of forecasted anomalous conditions likely to result based on the impact of external conditions with respect to the current aircraft state while performing a landing and helps pilots assess the situation and make safe decisions on whether to land (using recommended settings or other recommended actions) or initiate a go around by analyzing the historical data associated with prior anomalous conditions and comparatively identifying when the current aircraft state and external conditions correlated to prior occurrences of an anomalous condition, and providing corresponding recommendations based on pilot actions that have been previously shown to be successful.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an ASIC.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of assisting operation of a vehicle, the method comprising:
obtaining, via one or more systems onboard the vehicle, status information indicative of a current state of the vehicle;
forecasting an anomalous condition is likely for the vehicle based on a relationship between the current state of the vehicle and a first set of one or more historical vehicle states associated with prior occurrence of the anomalous condition;
analyzing a second set of one or more historical vehicle states similar to the current state of the vehicle to identify a remedial operator action correlative to avoidance of the anomalous condition based on prior operator actions associated with the second set of one or more historical vehicle states; and
providing an indication of the remedial operator action to an operator of the vehicle.

2. The method of claim 1, wherein forecasting the anomalous condition comprises detecting when a probability of occurrence of the anomalous condition is greater than a minimum detection threshold using a forecast model to calculate the probability of occurrence as a function of input time series data streams comprising the current state of the vehicle.

3. The method of claim 2, further comprising training the forecast model to calculate the probability of occurrence as a function of input time series data streams comprising the current state of the vehicle using historical time series data streams comprising the first set of one or more historical vehicle states associated with the prior occurrence of the anomalous condition.

4. The method of claim 1, wherein analyzing the second set of one or more historical vehicle states similar to the current state of the vehicle comprises inputting the current state of the vehicle to a recommendation model configured to output indication of the remedial operator action, wherein the recommendation model is trained using the second set of one or more historical vehicle states.

5. The method of claim 1, further comprising obtaining, via one or more external data sources, contextual information associated with a route of the vehicle, wherein forecasting the anomalous condition comprises detecting when a probability of occurrence of the anomalous condition is greater than a minimum detection threshold using a forecast model to calculate the probability of occurrence as a function of input time series data streams comprising the current state of the vehicle and the contextual information.

6. The method of claim 5, wherein:
the vehicle comprises an aircraft;
the contextual information comprises runway condition information associated with a destination runway of a flight plan for the aircraft;
the anomalous condition comprises a runway overrun; and
the remedial operator action comprises a recommended pilot action to reduce likelihood of the runway overrun.

7. The method of claim 1, further comprising obtaining, via one or more external data sources, contextual information associated with a route of the vehicle, wherein analyzing the second set of one or more historical vehicle states similar to the current state of the vehicle comprises inputting the current state of the vehicle and the contextual information to a recommendation model configured to output indication of the remedial operator action, wherein the recommendation model is trained using the second set of one or more historical vehicle states.

8. The method of claim 7, wherein:
the vehicle comprises an aircraft;
the contextual information comprises runway condition information associated with a destination runway of a flight plan for the aircraft; and
the second set of one or more historical vehicle states includes respective runway condition information for the respective historical vehicle states.

9. The method of claim 8, wherein:
the anomalous condition comprises a runway overrun; and
the remedial operator action comprises a recommended pilot action to reduce likelihood of the runway overrun.

10. A computer-readable medium having computer-executable instructions stored thereon that, when executed by a processing system of a cloud-based computing system, cause the processing system to:
obtain, via one or more systems onboard a vehicle, status information indicative of a current state of the vehicle;
forecast an anomalous condition is likely for the vehicle based on a relationship between the current state of the vehicle and a first set of one or more historical vehicle states associated with prior occurrence of the anomalous condition;
analyze a second set of one or more historical vehicle states similar to the current state of the vehicle to identify a remedial operator action correlative to avoidance of the anomalous condition based on prior operator actions associated with the second set of one or more historical vehicle states; and
provide an indication of the remedial operator action to an operator of the vehicle.

11. The computer-readable medium of claim 10, wherein the instructions are configurable to cause the processing system to detect when a probability of occurrence of the anomalous condition is greater than a minimum detection threshold using a forecast model to calculate the probability of occurrence as a function of input time series data streams comprising the current state of the vehicle.

12. The computer-readable medium of claim 11, wherein the instructions are configurable to cause the processing system to train the forecast model to calculate the probability of occurrence as a function of input time series data streams comprising the current state of the vehicle using historical time series data streams comprising the first set of one or more historical vehicle states associated with the prior occurrence of the anomalous condition.

13. The computer-readable medium of claim 10, wherein the instructions are configurable to cause the processing system to input the current state of the vehicle to a recommendation model configured to output indication of the remedial operator action, wherein the recommendation model is trained using the second set of one or more historical vehicle states.

14. The computer-readable medium of claim 10, wherein the instructions are configurable to cause the processing system to obtain, via one or more external data sources, contextual information associated with a route of the vehicle, wherein forecasting the anomalous condition comprises detecting when a probability of occurrence of the anomalous condition is greater than a minimum detection threshold using a forecast model to calculate the probability of occurrence as a function of input time series data streams comprising the current state of the vehicle and the contextual information.

15. The computer-readable medium of claim 14, wherein:
the vehicle comprises an aircraft;
the contextual information comprises runway condition information associated with a destination runway of a flight plan for the aircraft;
the anomalous condition comprises a runway overrun; and
the remedial operator action comprises a recommended pilot action to reduce likelihood of the runway overrun.

16. The computer-readable medium of claim 10, wherein the instructions are configurable to cause the processing system to:
obtain, via one or more external data sources, contextual information associated with a route of the vehicle; and
input the current state of the vehicle and the contextual information to a recommendation model configured to output indication of the remedial operator action, wherein the recommendation model is trained using the second set of one or more historical vehicle states.

17. The computer-readable medium of claim 16, wherein:
the vehicle comprises an aircraft;
the contextual information comprises runway condition information associated with a destination runway of a flight plan for the aircraft; and
the second set of one or more historical vehicle states includes respective runway condition information for the respective historical vehicle states.

18. A cloud-based computing system comprising:
a data storage element to maintain historical data associated with prior operation of one or more vehicles, the historical data comprising at least a first set of one or more historical vehicle states associated with prior occurrence of an anomalous condition and prior operator actions associated with a second set of one or more historical vehicle states; and
a processing system coupled to the data storage element to provide an assistance service, wherein the assistance service is configurable to:
obtain, via one or more systems onboard a vehicle, status information indicative of a current state of the vehicle;
forecast the anomalous condition is likely for the vehicle based on a relationship between the current state of the vehicle and the first set of one or more historical vehicle states associated with the prior occurrence of the anomalous condition;
identify a remedial operator action correlative to avoidance of the anomalous condition based on the prior operator actions associated with the second set of one or more historical vehicle states; and
provide an indication of the remedial operator action to an operator of the vehicle.

19. The cloud-based computing system of claim 18, wherein the assistance service is configurable to:
obtain, via one or more external data sources, contextual information associated with a route of the vehicle; and
input the current state of the vehicle and the contextual information to a recommendation model configured to output indication of the remedial operator action, wherein the recommendation model is trained using the second set of one or more historical vehicle states to identify the remedial operator action correlative to nonoccurrence of the anomalous condition.

20. The cloud-based computing system of claim 19, wherein:
the vehicle comprises an aircraft;
the contextual information comprises runway condition information associated with a destination runway of a flight plan for the aircraft; and
the second set of one or more historical vehicle states includes respective runway condition information for the respective historical vehicle states.
